(19) United States
(12) Patent Application Publication
(10) Pub. No.: US 2011/0119104 A1
(43) Pub. Date: May 19, 2011

(54) INDIVIDUALIZED BEHAVIOR-BASED SERVICE BUNDLING AND PRICING

(75) Inventors: Jonathan Levine, Rochester, NY (US); Yu-An Sun, Webster, NY (US)

(73) Assignee: XEROX CORPORATION, Norwalk, CT (US)

(21) Appl. No.: 12/619,905

(22) Filed: Nov. 17, 2009

(51) Int. Cl. G06Q 10/00; G06N 5/02

(52) U.S. Cl. 705/7.25; 706/47; 705/7.35; 705/412

(57) ABSTRACT

A method and system analyze service applications being utilized within a computerized network environment using an analytics module of a computerized device to produce operational information of the service applications and usage information of the service applications. The operational information is analyzed using an application behavior analysis module of the computerized device to produce application behavior profiles. The usage information is analyzed using an application association analysis module of the computerized device to produce bundles of the services applications. The application behavior profiles and the bundles of the service applications are analyzed using a pricing module of the computerized device to produce price ranges for each bundle of service applications and cost profiles for each bundle of service applications.

### BACKGROUND AND SUMMARY

Embodiments herein generally relate to behavior-based service bundling and pricing for printing services and more particularly to a multi-module system and method that automatically provides bundles, as well as pricing and cost profiles for the bundles.

A common pricing model for services that are software or computer oriented is a subscription based pricing model. The subscription based pricing model allows users to pay a monthly or yearly fee for the services offered at a flat rate. Some companies offer volume discounts for such services.

The profitability of a subscription based pricing model is greatly affected by the accuracy of cost estimation, and such estimates are commonly made without knowledge of the cost profiles. Marginal costs for user A could be very different than those for user B because the different users' usage behaviors may differ, even when both users are using the same computerized service. For example, user A might be using a service to process color-intensive documents, and user B might be using the same service to process black-and-white text-intensive documents. The black-and-white processing does not require as much central processing unit (CPU) time, which would result in a smaller marginal cost for user B.

The embodiments herein address this issue by providing a value-based pricing model. The embodiments herein incorporate software behavior profiling, usage information mining, and historical pricing analysis into a value-based pricing model. This enhanced pricing model is designed to produce a price range for each user on a cloud platform and for categories of users.

There are two processes utilized by embodiments herein that generate a price range unique to each user. One process discovers a potential bundle of one or more services, and another process gives the bundle a suggested price range. Historical pricing contributes to the upper bound of the price range and behavior profiling contributes to the lower bound (marginal cost). The embodiments herein provide service bundling suggestions and customized prices for different users based on their usage behavior profiles.

Thus, system and methods herein analyze service applications such as printing service applications being utilized within a computerized network environment using an analytics module of a computerized device to produce operational information of the printing service applications and usage information of the printing service applications. The printing service applications comprise printing services, scanning services, optical character recognition services, file conversion services, e-mail services, document color conversion services, etc.

The operational information is analyzed using an application behavior analysis module of the computerized device to produce application behavior profiles. The embodiments herein can receive requests from service providers into the application behavior analysis module when analyzing the operational information. The analyzing of the operational information by the application behavior analysis module involves profiling service usage to identify different marginal costs for different behavior profiles and different marginal costs for different user behaviors.

The usage information is similarly analyzed using an application association analysis module of the computerized device to produce bundles of the services applications. The analyzing of the usage information by the application association analysis module comprises data mining and rule-based association analysis processing. The data mining identifies potential services to be bundled. The rule-based association analysis combines the potential services into the bundles of services according to pre-established association rules.

The application behavior profiles and the bundles of the printing service applications are analyzed using a pricing module of the computerized device to produce price ranges for each bundle of printing service applications and cost profiles for each bundle of printing service applications. The pricing model performs historical pricing to produce an estimate price based on price history of a reference bundle. Alternatively, the pricing module can compute the bundle price by adding up current prices of all printing service applications included within the reference bundle.

These and other features are described in, or are apparent from, the following detailed description.

### BRIEF DESCRIPTION OF THE DRAWINGS

Various exemplary embodiments of the systems and methods are described in detail below, with reference to the attached drawing figures, in which:

FIG. 1 is a schematic diagram illustrating a value-based pricing model;

FIG. 2 is a schematic diagram of an apparatus according to embodiments herein;

FIG. 3 is a schematic diagram illustrating the creation of service bundles;

FIG. 4 is a table illustrating service application usage information;

FIG. 5 is a table listing service application behavior profiles of different users and different services;

FIG. 6 is a table listing sample behavior profiles of different users and different services;

FIG. 7 is a table listing sample behavior profiles of different users and different services;

FIG. 8 is a flowchart illustrating embodiments herein; and

FIG. 9 is a schematic diagram of a computerized device according to embodiments herein.

### DETAILED DESCRIPTION

As mentioned above, the embodiments herein provide a value-based pricing model and will incorporate software behavior profiling, usage information mining, and historical pricing analysis of reference pricing into the value-based pricing model. This enhanced pricing model is designed to produce a price range for each user on a cloud platform and for categories of users.

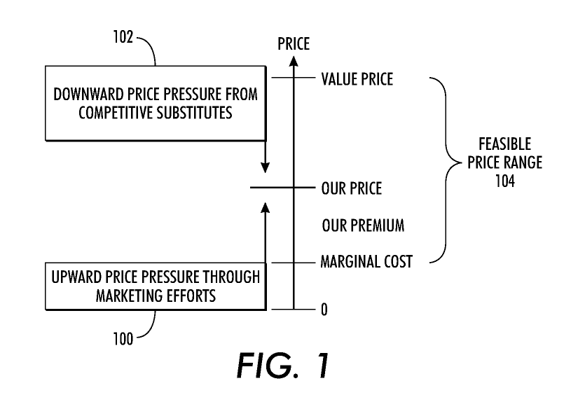

One value-based pricing model is illustrated in FIG. 1. In FIG. 1, the output of a value-based pricing analysis is an interval of a feasible price range 104 with a lower bound of a marginal cost and an upper bound of a customer's valuation of this product (value price). Setting the final price requires taking competition 102 and marketing strategy 100 into consideration. More specifically, the competition 102 exerts a downward price pressure from competitive substitutes and the marketing strategy 100 exerts upward price pressure through marketing efforts. The difference between the marginal cost and the final price represents the amount of profit. A higher final price would produce greater profits.

In the value-based pricing model shown in FIG. 1, the difficulty is identifying the upper bound of the price range, i.e., the maximum a customer is willing to pay for a service. The embodiments herein improve the ability to find the upper bound for a particular customer or identify the upper bound for categories of users who use services or workflows in similar ways.

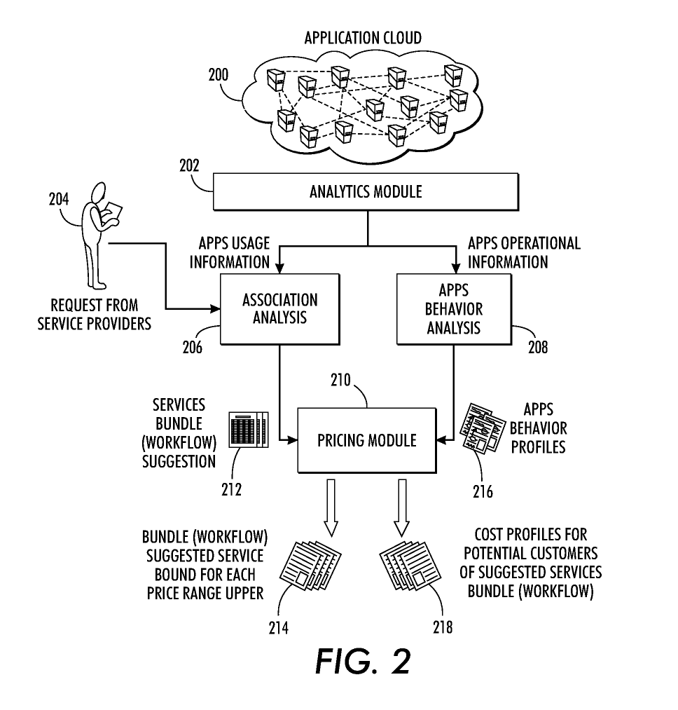

More specifically, as shown in FIG. 2, the embodiments herein utilize multiple modules. The modules described herein can comprise software elements, dedicated hardware devices, and/or a combination of such items. One such module is the analytics module 202 which obtains information from the application cloud 200. The term cloud is used as a metaphor for local or wide area networks, such as the Internet, based on how the Internet is depicted in computer network diagrams and is an abstraction for the complex infrastructure it conceals.

Cloud computing is an example of computing in which dynamically scalable and often virtualized resources are provided as a service over the Internet. Users need not have knowledge of, expertise in, or control over the technology infrastructure in the “cloud” that supports them. The cloud concept generally incorporates combinations of the following: infrastructure as a service (IaaS); platform as a service (PaaS); and software as a service (SaaS). Cloud computing services often provide common business applications online that are accessed from a web browser, while the software and data are stored on servers.

The application cloud 200 represents many different services that can be offered over local or wide area networks (such as the Internet). For example, the services that can be offered within the application cloud 200 could include printing services, scanning services, optical character recognition (OCR) services, format conversion services (portable document format (PDF) conversion services), document color conversion services (monochrome-to-color; color-to-monochrome), etc.

The analytics module 202 searches these networks within the application cloud 200 to identify the usage information of the various service applications and to identify the operational information of the various service applications using, for example, data mining. The details of data mining are well-known by those ordinarily skilled in the art and are not discussed in detail herein. For a discussion of data mining features see U.S. Pat. No. 7,529,731, the complete disclosure of which is incorporated herein by reference.

The operational information that is obtained by the analytics module 202 includes information regarding how each service consumes processing resources. For example, each service will utilizes a certain amount of disk storage, network bandwidth, CPU processing time, etc., and these values are included within the operational information obtained by the analytics module 202.

While the service application operational information is based on determining resource utilization, the service application usage information relates more to tracking the different ways in which the different users utilize the service applications. The usage information that is obtained by the analytics module 202 identifies the service used, the user that used the service, and the amount of usage that the user obtained. FIG. 4 is a table 400 that illustrates such usage information. This table identifies the user, the service used, and the total number of accesses (or times that the service was used).

An additional module is an association analysis module 206. The association analysis module 206 performs data mining and association analysis on the application usage information obtained by the analytics module 202 to identify potential popular workflows. The association analysis module 206 bundles services and applications based on analysis and association rules, sometimes fully automatically, and sometimes based on requests from service providers 204. Therefore, the association analysis module 206 outputs various service bundles (workflow) suggestions 212. The association analysis module 206 performs data mining and association analysis to discover what items and/or services within the service application usage information should be bundled.

The association analysis module 206 utilizes data mining technology and association rule learning. Association rule learning uses pre-established rules to identify relationships between different variables in a database. The inputs to the association analysis module 206 include the usage information of all the applications and requests from a service provider. Any service provider can utilize the embodiments herein to obtain suggestions for future service bundling or workflows and the price range for such bundling.

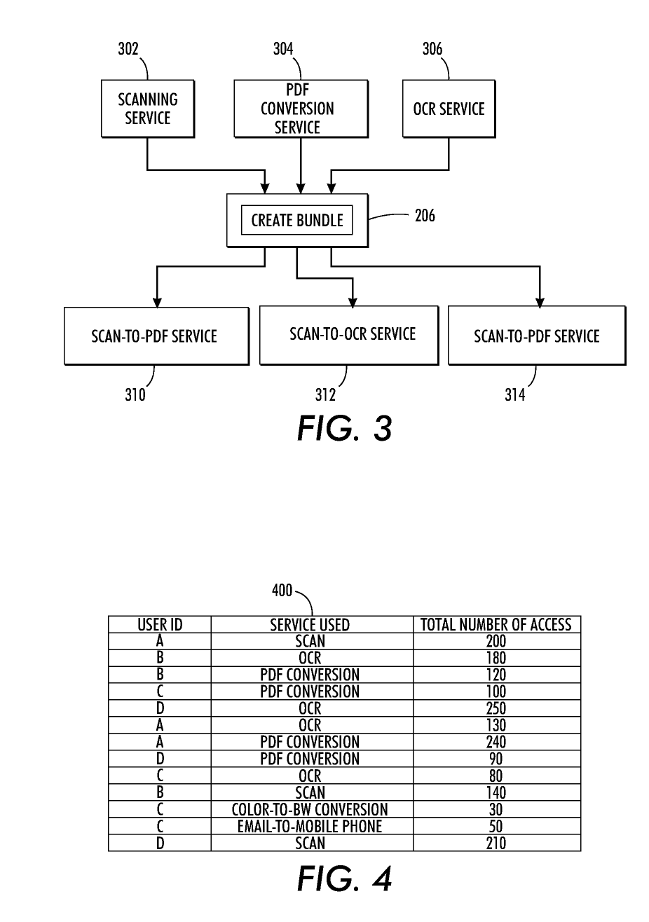

For example, as shown in FIG. 3, the association analysis module 206 can bundle the cloud-based services, such as scanning services 302, portable document format (PDF) conversion services 304, and optical character recognition (OCR) services 306. In FIG. 3, item 206 represents the association analysis module which creates bundles of services 310, 312, and 314. For example, one bundle that the association analysis module 206 can create is the service 310 that scans items and automatically creates PDF files from the scanned items (scan-to-PDF Service). Another bundle that the association analysis module 206 creates is the scan-to-OCR service 312, which scans an item and performs optical character recognition on the item. Yet another bundle that the association analysis module 206 creates is the OCR-to-PDF service 314 which performs optical character recognition on an image and creates a PDF document from the optically recognized characters. While three such bundles 310, 312, and 314 are illustrated in FIG. 3, those ordinarily skilled in the art would understand that many other bundles could be created and that the bundles illustrated in FIG. 3 are merely exemplary and not limiting.

Embodiments herein allow the service provider 204 to specify how many applications should be combined into a bundle. For example, the service provider might be only interested in providing a bundle of two existing applications and not interested in any bundle consists of more than two applications. Similarly, bundles of 3, 4, 5, 6, etc., could be desired. Therefore, the association analysis module 206 utilizes data mining technology and association rule learning to bundle otherwise separate and distinct application services into service bundles.

Another such module is an application behavior analysis module 208 which obtains the service application operational information produced by the analytics module 202 from the application cloud 200. The application behavior analysis module 208 performs behavior profiling of software usage within the application cloud 200 to produce application behavior profiles 216.

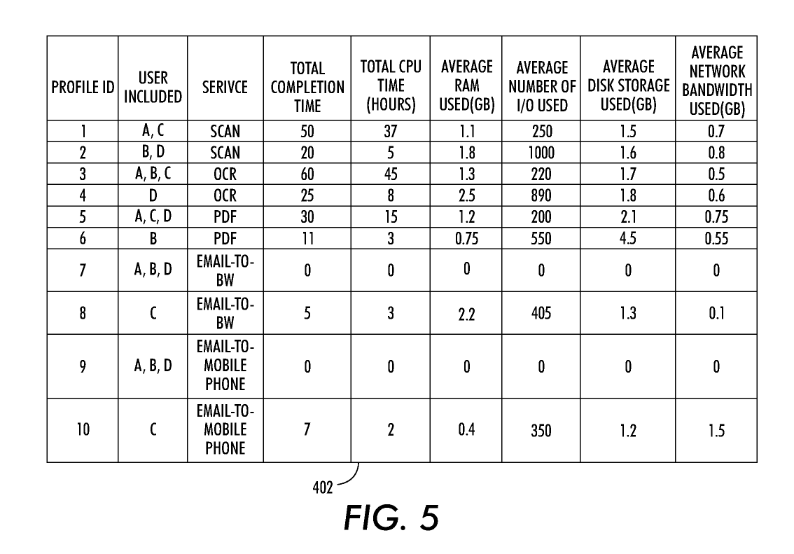

The application behavior analysis module 208 identifies marginal costs for individual users by software behavior profiling. To generate a behavior profile for an individual user, the application behavior analysis module 208 takes operational information of each service application as input. For example, one exemplary behavior profile within the application's operational information could include the following information: the user's included; the service provided; the total completion time; the total CPU time used; the average memory (RAM) used; the average number of I/O accesses; the average disk storage used; and the average network bandwidth used, as shown in the table 402 in FIG. 5.

More specifically, FIG. 5 illustrates various profiles that are developed from the service application operational information where different groups of users are included within different profiles, and where each different profile presents a different mixture of computer resource consumption. For example, each profile could include data such as which users are included in the service, an identification of the service, the total completion time for the service, the total CPU time for the service, the average random access memory (RAM) used during the service, the average number of inputs/outputs (I/O) used during the service, the average disk storage required for the service, the average network bandwidth used for the service, etc.

This profiling improves the accuracy of the lower price bound by identifying different marginal costs for different behavior profiles or for different user behaviors. In other words, by accumulating the computer resource consumption within different profiles, the amount of resource utilization that is associated with each user or group of users can be determined, and this information can be combined with the costs of the various computerized resources to establish marginal costs (lower price boundaries) for each different user or groups of users.

An additional module shown in FIG. 2 is a pricing module 210. The pricing module 210 takes the service bundle (workflow) suggestions 212 and the behavior profiles 216 as input. The pricing module 210 calculates the upper bound of the price range for each suggested service bundle 214 for each user based on what that user (and/or similar users) has been charged for the services included within the bundle previously. The lower price boundary is each user's marginal cost for the bundle.

If a bundle with the same service components previously exists and is within the application behavior profiles 216, the pricing module 210 retrieves the historical pricing data for each individual service this bundle contains to calculate an estimated upper bound price (based on the price history of the previously existing bundle). If no similar bundle has been created previously, the pricing module 210 computes the new bundle's upper bound price by linearly combining the current upper bound price of all applications included within the new bundle. The upper bound price of such applications that would be included within the new bundle is obtained from the application behavior profiles 216.

In addition, the pricing module 210 calculates the cost profiles for potential customers for each suggested service bundle 218 to establish the lower price boundary. The cost profiles are calculated by determining how much of each computerized resource (such as those shown in FIG. 5) a user (and/or similar users) has used in the past multiplied by the cost of each of those computerized resources.

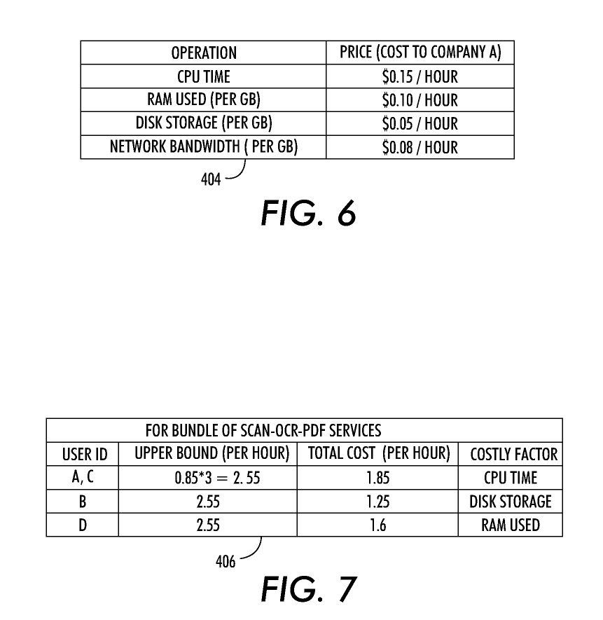

An exemplary chart 404 of costs such as CPU time, RAM usage, disk storage usage, network bandwidth usage, etc., is shown in FIG. 6. The data provided in FIG. 6 can be pre-established or supplied by the user, and can be based on industry standards, operational history, or personal knowledge. Such data can change over time depending upon how an industry or organization tracks such costs.

Thus, the pricing module 210 combines the output from both the application behavior module 208 and association analysis module 206 and generates a different price range for each potential customer that is currently using any applications included in the bundle suggestion. Since each user has a different price range due to a different behavior profile, the service provider could assign a different price for each customer, or the service provider could set a uniform price for all the users and issue discount (coupons) of different amounts to achieve differential pricing of each customer.

FIG. 7 illustrates an exemplary chart 406 of the price and cost values produced by the pricing module 210 for a three service bundle. As shown in FIG. 7, if each service has a historical upper bound price of 85¢, the bundle has an upper bound price of $2.55 (85¢ times 3). In this example, the upper bound price is the same for all users and for all services; however, the pricing could be different for different users and for different services, depending upon the pricing history. FIG. 7 also shows the total cost for each user or group of users calculated as described above. Note that the different users have different costs because of their different usage histories. FIG. 7 also illustrates the “costly factor” column which identifies a factor which has the highest cost for the user or group of users. The costly factor column helps provide additional information as to where potential cost savings may be for a given user or group of users, and this information can potentially be shared with the users.

Those ordinarily skilled in the art would understand that the data items included within the tables shown above (in FIGS. 4-7) is merely exemplary and that more or less data items could be included within each of the tables, depending upon the specific application involved.

In operation, for example, a document service provider could operate an application cloud or offer various service applications with the application cloud as the backend. Suppose company A provides 5 different application services, including scanning service, OCR service, PDF conversion service, color-to-black and white conversion service and email-to-mobile phone service. All 5 services could be historically priced the same at $0.85 per hour. In this example, there are only 4 different customers (A-D) using the 5 different services through the application cloud, but those ordinarily skilled in the art would understand that there could be less or many more customers.

Therefore, the upper price boundary for a given bundle would be based on historical pricing of the individual services that are combined together. The lower price boundary is based on each user's cost for the bundled services, as calculated above. Therefore, the price range can run from zero profit, where the bundle is sold for each user's individual cost, up to a profit margin provided by historical pricing. With the embodiments herein, those users who have relatively lower resource usage and have corresponding relatively lower costs may receive greater price discounts than other users (because the embodiments herein allow vendors to recognize that such users that use less resources present costs that are relatively less than other, higher resource, users). Thus, by providing information to the vendors as to which customers (users) use less resources, the embodiments herein allow the vendors to more properly allocate pricing for service bundles.

Company A can send a request to the document service provider, asking for a list of possible bundles based on the 5 services provided. Company A may specify the number of suggested bundles and the number of services each bundle contains. For example, company A may want to receive a suggested list of 1 bundle of 3 services. The association analysis module 206 takes the usage information of all 4 users and 5 different services as input. The association analysis module 206 could output a scan-OCR-PDF bundle since user A, B and D all use these three services (see FIG. 5).

With the price ranges generated by the pricing module 210, company A can set a different price of this suggested bundle for each user. Note that user A and C have the same behavior profile for scan, OCR and PDF conversion services in FIG. 5, therefore the price range suggestion is the same for them.

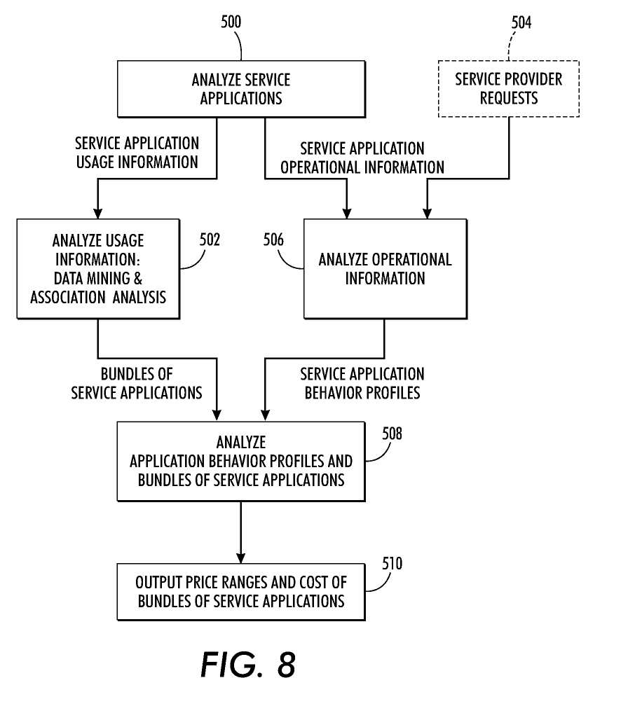

As shown in flowchart form (in FIG. 8), in item 500 system and methods herein analyze service applications, such as printing service applications, being utilized within a computerized network environment. The analysis in item 500 uses the analytics module of the computerized device to produce operational information of the printing service applications and usage information of the printing service applications. The printing service applications comprise, for example, printing services, scanning services, optical character recognition services, file conversion services, e-mail services, document color conversion services, etc.

The usage information of the service applications is then analyzed in item 502 using the application association analysis module of the computerized device to produce bundles of the services applications. The analyzing of the usage information 502 by the application association analysis module can comprises data mining and/or rule-based association analysis processing. Such data mining identifies potential service applications to be bundled. The rule-based association analysis combines the potential service applications into the bundles of service applications according to pre-established association rules.

The operational information of the service applications is similarly analyzed in item 506 using the application behavior analysis module of the computerized device to produce service application behavior profiles. The embodiments herein can optionally receive requests from service providers into the application behavior analysis module when analyzing the operational information, as shown by item 504. The analyzing of the operational information 506 by the application behavior analysis module can comprise profiling service usage to identify different marginal costs for different behavior profiles and different marginal costs for different user behaviors.

The service application behavior profiles and the bundles of the printing service applications are analyzed in item 508 using a pricing module of the computerized device to produce price ranges for each bundle of printing service applications and cost profiles for each bundle of printing service applications. The analyzing of the application behavior profiles and the bundles of the printing service applications by the pricing module in item 508 can comprise performing a historical pricing analysis to produce an estimate price based on the price history of a reference bundle. Alternatively, the analyzing of the application behavior profiles and the bundles of the printing service applications by the pricing module 508 can comprise computing the bundle price by linear adding up of the current prices of all printing service applications included within the reference bundle.

In item 510, both the price ranges for each bundle of printing service applications and cost profiles for each bundle of printing service applications are output. Thus, the embodiments provide dynamic cost profiling based on usage information and, therefore, provide an accurate marginal cost estimation. Further, the embodiments herein provide an association analysis that identifies potential service/workflow bundles.

Providing an application cloud for both service providers and users is an example of a platform that benefits from identifying the best pricing model for the application cloud marketplace using embodiments herein. By offering service providers a pricing model well suited in the application cloud market, more service providers would join a corporation using the embodiments herein. Also, the output generated from the embodiments herein, (behavior profiles and bundle suggestions), can be used to track changes in market conditions over time. The embodiments herein also serve as a reference for market analysis by identifying prices for similar services, where competing service providers submit request to analyze similar services.

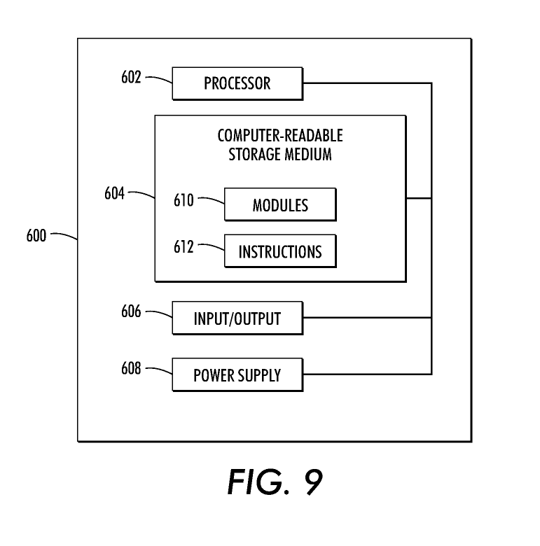

FIG. 9 illustrates an exemplary computerized device 600 according to embodiments herein. The computerized device 600 can comprise a general purpose or special purpose computerized device and can comprise a single device or a number of computerized devices that are interconnected by a wired or wireless, local or wide area network. The computerized device includes a processor 602, a computer-readable storage medium 604, an input/output 606, and a power supply 608. The processor 602 can comprise any form of computerized logical decision making device whether currently known or developed in the future. The computer-readable storage medium 604 can comprise any form of storage device, such as magnetic medium, optical medium, electronic capacitor storage and any other storage medium whether currently known or developed in the future. The input/output 606 can comprise a wired or wireless connection to any other computer or computer network, one or more graphic user interfaces, one or more printing devices, one or more telephonic devices, etc. The power supply 608 is intended to represent all forms of hardware required to allow the computerized device 600 to operate including alternating current and direct current sources, wiring, computer boards and computer packaging, physical support structures, etc. The various modules 610 that are mentioned above (206, 208, 210, etc.) and other computer-executable instructions 612 can be maintained within the computer-readable storage medium 604. These modules 610 and instructions 612 are executed by the processor 602 to perform the various functions described in this disclosure.

Many computerized devices are discussed above. Computerized devices that include chip-based central processing units (CPU's), input/output devices (including graphic user interfaces (GUI), memories, comparators, processors, etc. are well-known and readily available devices produced by manufacturers such as Dell Computers, Round Rock Tex., USA and Apple Computer Co., Cupertino Calif., USA. Such computerized devices commonly include input/output devices, power supplies, processors, electronic storage memories, wiring, etc., the details of which are omitted herefrom to allow the reader to focus on the salient aspects of the embodiments described herein. Similarly, scanners and other similar peripheral equipment are available from Xerox Corporation, Norwalk, Conn., USA and the details of such devices are not discussed herein for purposes of brevity and reader focus.

The terms printer or printing device as used herein encompasses any apparatus, such as a digital copier, bookmaking machine, facsimile machine, multi-function machine, etc., which performs a print outputting function for any purpose. The details of printers, printing engines, etc., are well-known by those ordinarily skilled in the art and are discussed in, for example, U.S. Pat. No. 6,032,004, the complete disclosure of which is fully incorporated herein by reference. The embodiments herein can encompass embodiments that print in color, monochrome, or handle color or monochrome image data. All foregoing embodiments are specifically applicable to electrostatographic and/or xerographic machines and/or processes.

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. The claims can encompass embodiments in hardware, software, and/or a combination thereof. Unless specifically defined in a specific claim itself, steps or components of the embodiments herein cannot be implied or imported from any above example as limitations to any particular order, number, position, size, shape, angle, color, or material.

What is claimed is:

1. A method comprising:
analyzing service applications being utilized within a computerized network environment using an analytics module of a computerized device to produce operational information of said service applications and usage information of said service applications;
analyzing said operational information using an application behavior analysis module of said computerized device to produce application behavior profiles;
analyzing said usage information using an application association analysis module of said computerized device to produce bundles of said services applications; and
analyzing said application behavior profiles and said bundles of said service applications using a pricing module of said computerized device to produce price ranges for each bundle of service applications and cost profiles for each bundle of service applications.

2. The method according to claim 1, further comprising receiving requests from service providers into said application behavior analysis module when analyzing said operational information.

3. The method according to claim 1, said service applications comprising printing services, scanning services, optical character recognition services, file conversion services, e-mail services, and document color conversion services.

4. The method according to claim 1, said analyzing of said usage information by said application association analysis module comprising at least one of data mining and rule-based association analysis processing;
said data mining identifying potential services to be bundled; and
said rule-based association analysis combining said potential services into said bundles of services according to pre-established association rules.

5. The method according to claim 1, said analyzing of said operational information by said application behavior analysis module comprising profiling service usage to identify different marginal costs for different behavior profiles and different marginal costs for different user behaviors.

6. The method according to claim 1, said analyzing of said application behavior profiles and said bundles of said service applications by said pricing module comprising at least one of:
using historical pricing information to produce an estimate price of a reference bundle; and
computing bundle price by adding up current prices of all service applications included within said reference bundle.

7. A method comprising:
analyzing printing service applications being utilized within a computerized network environment using an analytics module of a computerized device to produce operational information of said printing service applications and usage information of said printing service applications;
analyzing said operational information using an application behavior analysis module of said computerized device to produce application behavior profiles;
analyzing said usage information using an application association analysis module of said computerized device to produce bundles of said services applications; and
analyzing said application behavior profiles and said bundles of said printing service applications using a pricing module of said computerized device to produce price ranges for each bundle of printing service applications and cost profiles for each bundle of printing service applications.

8. The method according to claim 7, further comprising receiving requests from service providers into said application behavior analysis module when analyzing said operational information.

9. The method according to claim 7, said printing service applications comprising printing services, scanning services, optical character recognition services, file conversion services, e-mail services, and document color conversion services.

10. The method according to claim 7, said analyzing of said usage information by said application association analysis module comprising at least one of data mining and rule-based association analysis processing;
said data mining identifying potential services to be bundled; and
said rule-based association analysis combining said potential services into said bundles of services according to pre-established association rules.

11. The method according to claim 7, said analyzing of said operational information by said application behavior analysis module comprising profiling service usage to identify different marginal costs for different behavior profiles and different marginal costs for different user behaviors.

12. The method according to claim 7, said analyzing of said application behavior profiles and said bundles of said printing service applications by said pricing module comprising at least one of:
using historical pricing information to produce an estimate price of a reference bundle; and
computing bundle price by adding up current prices of all printing service applications included within a bundle.

13. An apparatus comprising:
an analytics module analyzing service applications being utilized within a computerized network environment to produce operational information of said service applications and usage information of said service applications;
an application behavior analysis module analyzing said operational information to produce application behavior profiles;
an application association analysis module analyzing said usage information to produce bundles of said services applications; and
a pricing module analyzing said application behavior profiles and said bundles of said service applications to produce price ranges for each bundle of service applications and cost profiles for each bundle of service applications.

14. The apparatus according to claim 13, said application behavior analysis module receiving requests from service providers when analyzing said operational information.

15. The apparatus according to claim 13, said service applications comprising printing services, scanning services, optical character recognition services, file conversion services, e-mail services, and document color conversion services.

16. The apparatus according to claim 13, said analyzing of said usage information by said application association analysis module comprising at least one of data mining and rule-based association analysis processing;
said data mining identifying potential services to be bundled; and
said rule-based association analysis combining said potential services into said bundles of services according to pre-established association rules.

17. The apparatus according to claim 13, said analyzing of said operational information by said application behavior analysis module comprising profiling service usage to identify different marginal costs for different behavior profiles and different marginal costs for different user behaviors.

18. The apparatus according to claim 13, said analyzing of said application behavior profiles and said bundles of said service applications by said pricing module comprising at least one of:
using historical pricing information to produce an estimate price of a reference bundle; and
computing bundle price by adding up current prices of all service applications included within a bundle.

19. A computer-readable storage medium storing instructions executable by a computerized device, said instructions causing said computerized device to perform a method comprising:
analyzing service applications being utilized within a computerized network environment using an analytics module of a computerized device to produce operational information of said service applications and usage information of said service applications;
analyzing said operational information using an application behavior analysis module of said computerized device to produce application behavior profiles;
analyzing said usage information using an application association analysis module of said computerized device to produce bundles of said services applications; and
analyzing said application behavior profiles and said bundles of said service applications using a pricing module of said computerized device to produce price ranges for each bundle of service applications and cost profiles for each bundle of service applications.

20. The computer-readable storage medium according to claim 19, said method further comprising receiving requests from service providers into said application behavior analysis module when analyzing said operational information.

21. The computer-readable storage medium according to claim 19, said service applications comprising printing services, scanning services, optical character recognition services, file conversion services, e-mail services, and document color conversion services.

22. The computer-readable storage medium according to claim 19, said analyzing of said usage information by said application association analysis module comprising at least one of data mining and rule-based association analysis processing;
said data mining identifying potential services to be bundled; and
said rule-based association analysis combining said potential services into said bundles of services according to pre-established association rules.

23. The computer-readable storage medium according to claim 19, said analyzing of said operational information by said application behavior analysis module comprising profiling service usage to identify different marginal costs for different behavior profiles and different marginal costs for different user behaviors.
